(19) United States
(12) Patent Application Publication
(10) Pub. No.: US 2026/0036477 A1
(43) Pub. Date: Feb. 5, 2026

(54) TORQUE SENSOR

(71) Applicants: SINTOKOGIO, LTD., Nagoya-shi (JP); HARMONIC DRIVE SYSTEMS INC., Tokyo (JP)

(72) Inventors: Yoshikane TANAAMI, Nagoya-shi (JP); Miyuki HAYASHI, Nagoya-shi (JP); Shotaro MAMIYA, Nagoya-shi (JP); Satoru OBA, Tokyo (JP)

(73) Assignees: SINTOKOGIO, LTD., Nagoya-shi (JP); HARMONIC DRIVE SYSTEMS INC., Tokyo (JP)

(21) Appl. No.: 19/234,508

(22) Filed: Jun. 11, 2025

(30) Foreign Application Priority Data
Aug. 2, 2024 (JP) 2024-128223

(51) Int. Cl. G01L 3/18

(52) U.S. Cl. CPC G01L 3/18

(57) ABSTRACT

To reduce a length in an axial direction of a driving mechanism including a rotation motor, a reduction gear, and a torque sensor to downsize the driving mechanism. A force receiver (32) fixed between a motor case (16) and a reduction gear case (22) is disposed outside the reduction gear case (22) so as to surround the reduction gear case (22). A frame (36) fixed to an attachment part (26) is disposed outside the reduction gear case (22) so as to surround the reduction gear case (22). A plurality of beams (40) are disposed around the reduction gear case (22) so as to be spaced from each other. A strain measurement part (42) is provided to at least one of the beams (40).

This Nonprovisional application claims priority under 35 U.S.C. § 119 on Patent Application No. 2024-128223 filed in Japan on Aug. 2, 2024, the entire contents of which are hereby incorporated by reference.

### TECHNICAL FIELD

The present invention relates to a torque sensor configured to detect an output torque of a reduction gear.

### BACKGROUND ART

Patent Literature 1 discloses one component as a torque sensor configured to detect a motor torque of a rotation motor with use of a reaction torque acting on the rotation motor. The rotation motor disclosed in Patent Literature 1 is used to transmit a motor torque to an operation member referred to as a converter (also referred to as a rotation target). Therefore, the operation member is connected in series to the rotation motor (see, for example, FIG. 2 of Patent Literature 1). Further, in the technology disclosed in Patent Literature 1, a torque sensor is interposed in series between the rotation motor and the operation member in order to detect a motor torque transmitted from the rotation motor to the operation member. That is, in the prior art, the rotation motor, the torque sensor, and the operation member are disposed in series in this order. The configuration of the torque sensor (referred to as “torque converter” in Patent Literature 1) in accordance with the prior art will be briefly described as follows.

The torque sensor includes a ring-shaped motor plate disposed outside the output shaft of the rotation motor (referred to as a drive shaft of a motor in Patent Literature 1) so as to surround the output shaft. The motor plate is located on a base side of the output shaft of the rotation motor. The motor plate is fixed to a motor case of the rotation motor, and a lug part protruding outwards in a radial direction is formed in part in a circumferential direction of the motor plate.

The torque sensor includes a ring-shaped mounting plate disposed outside the output shaft of the rotation motor so as to surround the output shaft, and the mounting plate is located on a tip side of the output shaft of the rotation shaft. The mounting plate is fixed to an attachment base (referred to as “fixed plate” in Patent Literature 1) to which the rotation motor is to be attached, and a lug part protruding outwards in a radial direction is formed in part in a circumferential direction of the mounting plate.

The torque sensor includes an open ring (referred to as a flex ring in Patent Literature 1) disposed outside the output shaft of the rotation motor so as to surround the output shaft, and the open ring is located between the motor plate and the mounting plate. Respective lug parts (referred to as “flange” in Patent Literature 1) protruding outwards in a radial direction are formed at paired open ends of the open ring. A gap between the paired lug parts of the open ring is displaced in response to the reaction torque acting on the rotation motor. One lug part of the open ring is fixed to the lug part of the motor plate by a fastener, and the other lug part of the open ring is fixed to the lug part of the mounting plate by a fastener.

The torque sensor includes a strain measurement part provided in a position located opposite to the gap between the paired lug parts and on an inner peripheral surface of the open ring. The strain measurement part measures a curve (deflection) of the open ring. The measurement of the curve of the open ring by the strain measurement part enables detection of a motor torque of the rotation motor with use of a reaction torque acting on the rotation motor.

Note that the output shaft of the rotation motor is connected to the operation member (referred to as “converter” in Patent Literature 1). The rotation motor, the attachment base, and the torque sensor constitute a driving mechanism configured to drive the operation member to rotate.

### CITATION LIST

### Patent Literature

### [Patent Literature 1]

Published Japanese Translation of PCT International Application Tokuhyo No. 2017-512299

### SUMMARY OF INVENTION

### Technical Problem

In the prior art, as described above, the rotation motor, the torque sensor, and the operation member are disposed in series in this order. Further, in the torque sensor in accordance with the prior art, the motor plate, the mounting plate, and the open ring are disposed so as to surround the output shaft of the rotation motor. Therefore, when the output shaft of the rotation motor is connected to the operation member, it is required to set the length of the output shaft of the rotation motor to be larger than a length in an axial direction of the torque sensor. As a result, the length in an axial direction of a driving mechanism including the rotation motor and the torque sensor is increased, resulting in difficulty in downsizing the driving mechanism.

In a case where the rotation motor is used to transmit a motor torque to the operation member, a reduction gear may be used to adjust the motor torque to a desired magnitude. In this case, the reduction gear is interposed in series between the rotation motor and the torque sensor. That is, in a case where the rotation motor is used in combination with the reduction gear and the torque sensor, the rotation motor, the reduction gear, the torque sensor, and the operation member are disposed in series in this order. As a result, the length in an axial direction of a driving mechanism including the rotation motor, the reduction gear, and the torque sensor is increased, resulting in difficulty in downsizing the driving mechanism. For this reason, in a case where importance is placed on downsizing a length in an axial direction, it has been difficult to use a rotation motor, a reduction gear, and a torque sensor in combination.

It is thus an object of an aspect of the present invention to reduce a length in an axial direction of a driving mechanism including the rotation motor, the reduction gear, and the torque sensor to downsize the driving mechanism.

### Solution to Problem

In order to solve the foregoing problem, a torque sensor in accordance with an aspect of the present invention is a torque sensor configured to detect a reaction torque acting on a reduction gear in a rotation actuator including a rotation motor and the reduction gear connected in series to the rotation motor, the torque sensor including: a force receiver that is disposed outside a reduction gear case of the reduction gear so as to surround the reduction gear case, that is fixed between a motor case of the rotation motor and the reduction gear case, and that is configured to receive the reaction torque; a frame that is disposed outside the reduction gear case so as to surround the reduction gear case and that is fixed to an attachment part; a plurality of beams that are provided between the force receiver and the frame so as to couple the force receiver and the frame and that are disposed around the reduction gear case so as to be spaced from each other; and a strain measurement part that is provided to at least one beam of the plurality of beams and that is configured to measure a strain of the at least one beam.

### Advantageous Effects of Invention

According to an aspect of the present invention, it is possible to reduce a length in an axial direction of a driving mechanism including a rotation motor, a reduction gear, and a torque sensor to downsize the driving mechanism. Note that the reaction torque acting on the reduction gear can be construed as an output torque of the reduction gear (or a rotation actuator). Therefore, an aspect of the present invention serves as a torque sensor configured to detect a reaction torque acting on the reduction gear to detect an output torque of the reduction gear (or the rotation actuator).

### BRIEF DESCRIPTION OF DRAWINGS

FIG. 1 is a side view schematically illustrating a driving device in accordance with Embodiment 1 of the present invention.

FIG. 2 is a perspective view schematically illustrating the driving device in accordance with Embodiment 1 of the present invention.

FIG. 3 is a side cross-sectional view schematically illustrating a torque sensor in accordance with Embodiment 1 of the present invention.

FIG. 4 is a perspective view schematically illustrating the torque sensor in accordance with Embodiment 1 of the present invention when seen from the front.

FIG. 5 is a perspective view schematically illustrating the torque sensor in accordance with Embodiment 1 of the present invention when seen from the rear.

FIG. 6 is a side view schematically illustrating a driving device in accordance with Embodiment 2 of the present invention.

FIG. 7 is a perspective view schematically illustrating the driving device in accordance with Embodiment 2 of the present invention.

FIG. 8 is a side cross-sectional view schematically illustrating a torque sensor in accordance with Embodiment 2 of the present invention.

FIG. 9 is a perspective view schematically illustrating the torque sensor in accordance with Embodiment 2 of the present invention when seen from the front.

FIG. 10 is a perspective view schematically illustrating the torque sensor in accordance with Embodiment 2 of the present invention when seen from the rear.

### DESCRIPTION OF EMBODIMENTS

The following description will discuss embodiments of the present invention with reference to the drawings. In the specification and the claims of the present application, the “axial direction” refers to a direction parallel to a rotation shaft of a rotation motor or an output shaft of a reduction gear. In the drawings, “SD” refers to an axial direction, “SDa” refers to a front side or a front direction which is one side in an axial direction, and “SDb” refers to a rear side or a rear direction which is the other side in an axial direction.

### Embodiment 1

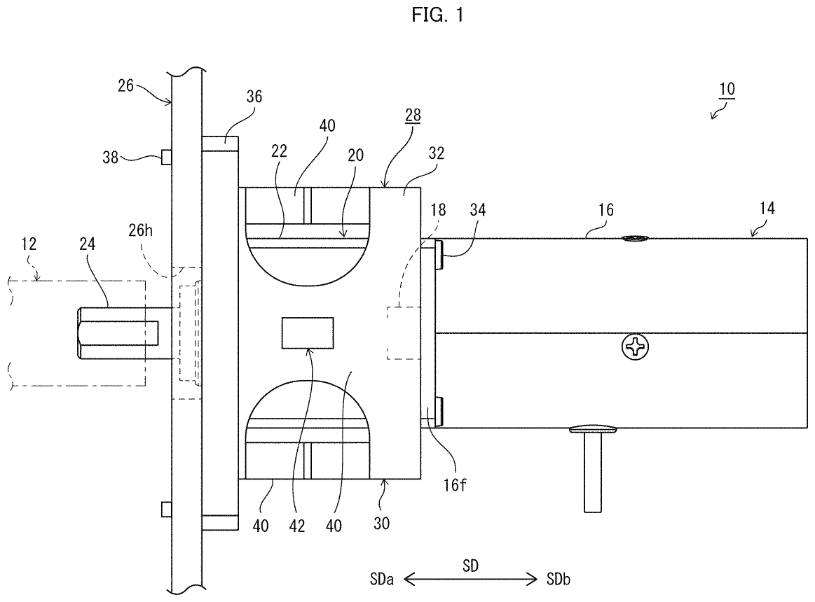

With reference to FIGS. 1 to 5, the following description will discuss Embodiment 1 of the present invention.

### (Overview of Driving Mechanism 10 and Rotation Motor 14)

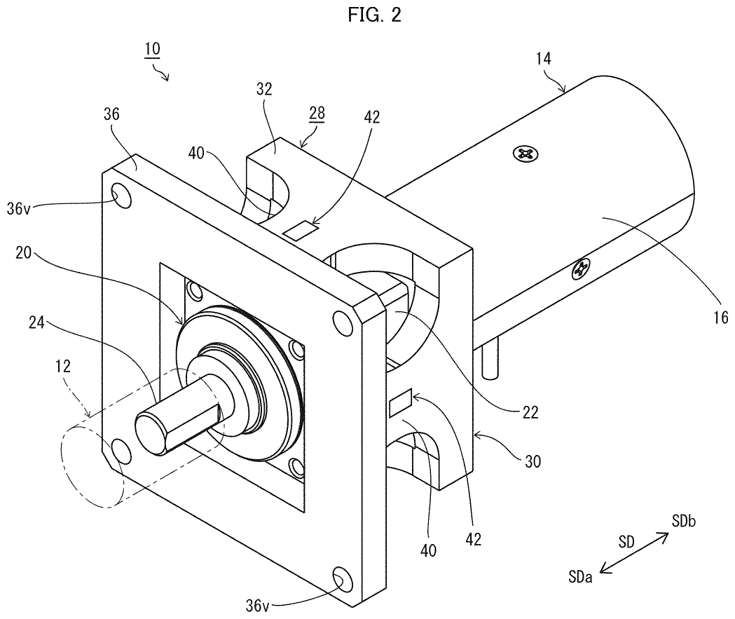

As illustrated in FIG. 1 and FIG. 2, a driving mechanism 10 in accordance with Embodiment 1 of the present invention is a mechanism configured to drive an operation member 12 to rotate and is, for example, used for a joint part of an arm of a robot. The driving mechanism 10 includes a rotation motor 14 for rotating the operation member 12. The rotation motor 14 includes a motor case 16 and a rotation shaft 18 rotatably provided in the motor case 16. A ring-shaped flange part 16f is formed at an end part on one side in an axial direction (front end part) of the motor case 16.

### (Reduction Gear 20 and Attachment Base 26)

As illustrated in FIG. 1 and FIG. 2, the driving mechanism 10 includes a reduction gear 20 configured to decelerate rotation of the rotation shaft 18 of the rotation motor 14, and the reduction gear 20 is connected in series to the rotation motor 14. The reduction gear 20 increases and outputs a motor torque of the rotation motor 14 to transmit the output torque to the operation member 12. The reduction gear 20 includes: a reduction gear case 22 connected in series to the flange part 16f of the motor case 16; and an output shaft 24 rotatably provided in the reduction gear case 22 and coupled in synchronization to the rotation shaft 18 of the rotation motor 14. The output shaft 24 of the reduction gear 20 is connected to the operation member 12, and the operation member 12 is driven to rotate by rotation of the output shaft 24. In a case where the reduction gear 20 is regarded as a part of the rotation motor 14, the reduction gear case 22 of the reduction gear 20 can be regarded as a part of the motor case 16, and the output shaft 24 of the reduction gear 20 can be regarded as an output shaft of the rotation motor 14.

### (Rotation Actuator)

In the driving mechanism 10 having such a configuration, the rotation motor 14 and the reduction gear 20 connected in series to the rotation motor 14 form an aspect of a rotation actuator. Depending on a desired output torque of the rotation actuator to be transmitted to the operation member 12, the reduction gear 20 of the rotation actuator may be omitted.

The driving mechanism 10 includes an attachment base 26 as an attachment part to which the rotation motor 14 is to be attached via the reduction gear 20. The attachment base 26 is provided with a through hole 26h through which the output shaft 24 of the reduction gear 20 is to be inserted.

### (Overview of Torque Sensor 28)

As illustrated in FIG. 1 and FIG. 2, the driving mechanism 10 includes a torque sensor 28 which is disposed outside the reduction gear case 22 of the reduction gear 20. The detailed configuration of the torque sensor 28 in accordance with Embodiment 1 of the present invention is as follows.

### (Strain Element 30, Force Receiver 32)

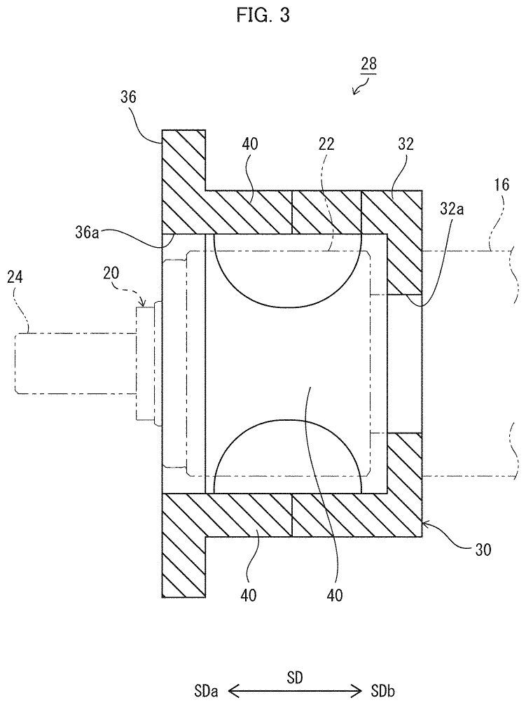

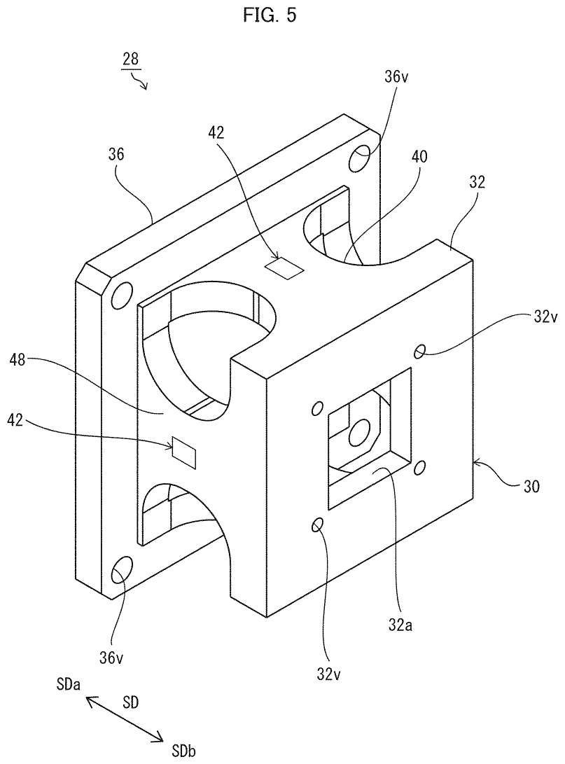

As illustrated in FIGS. 1 to 5, the torque sensor 28 includes a strain element 30 disposed outside the reduction gear case 22. The strain element 30 includes a force receiver 32 configured to receive a reaction torque acting on the reduction gear 20. The force receiver 32 is disposed outside the reduction gear case 22 so as to surround the reduction gear case 22. The force receiver 32 is formed into a square plate shape. In a center part of the force receiver 32, a square opening 32a through which the reduction gear case 22 is to be inserted is formed. The force receiver 32 is interposed between the motor case 16 and the reduction gear case 22, and is fixed to the motor case 16 and the reduction gear case 22 (see FIG. 1 and FIG. 3). That is, the motor case 16, the force receiver 32, and the reduction gear case 22 are fixed so as to prevent change in their relative positions. In the present embodiment, the force receiver 32 is provided with a plurality of (in the present embodiment, four) through holes 32v (see FIG. 5) through which set screws 34 are to be inserted. A plurality of through holes through which the set screws 34 are to be inserted are formed in positions corresponding to the plurality of through holes 32v, in the flange part 16f of the motor case 16. A plurality of screw holes to which the set screws 34 are to be fitted are formed in positions corresponding to the plurality of through holes 32v, on a rear bottom surface of the reduction gear case 22 which surface is located on a side closer to the force receiver 32 (the bottom surface on a side to which the arrow SDb points in FIG. 3). In addition, the plurality of set screws 34 fix the flange part 16f, the force receiver 32, and the reduction gear case 22 by screwing them together, with the flange part 16f and the force receiver 32 interposed between the heads of the screws and the reduction gear case 22. A structure for fixing the motor case 16, the force receiver 32, and the reduction gear case 22 is not limited to the structure of the present embodiment. The force receiver 32 may be formed into a rectangular plate shape other than a square shape. The opening 32a of the force receiver 32 may be formed into a rectangular shape other than a square shape, or a circular shape.

### (Frame 36)

As illustrated in FIGS. 1 to 5, the strain element 30 includes a frame 36 disposed outside the reduction gear case 22 so as to surround the reduction gear case 22. The frame 36 is spaced from the force receiver 32 in an axial direction and is not in contact with the reduction gear case 22. The frame 36 has a square outer shape (outline shape of the outer edge part thereof) and a square inner shape (outline shape of the inner edge part thereof). The frame 36 is located closer to the rotation motor than a part of the output shaft of the reduction gear which part protrudes from the reduction gear case. The frame 36 is fixed to the attachment base 26, which is an attachment part, by a plurality of set screws 38. The frame 36 is provided with a plurality of screw holes 36v to which set screws 38 are fitted. The outer shape and the inner shape of the frame 36 may each be a rectangular shape other than a square shape.

### (Beams 40)

As illustrated in FIGS. 1 to 5, the strain element 30 includes a plurality of beams 40 provided between the outer edge part of the force receiver 32 and the inner edge part of the frame 36 so as to couple the outer edge part and the inner edge part. The plurality of beams 40 are disposed along a circumferential direction around the reduction gear case 22 at equal intervals. The beams 40 are elastically deformable in response to the reaction torque acting on the reduction gear 20 in accordance with the output of the reduction gear 20, and center parts of the beams 40 each have a constricted shape. The plurality of beams 40 may be disposed at unequal intervals, provided that the plurality of beams 40 are disposed around the reduction gear case 22 so as to be spaced from each other. An edge part of each beam 40 may include a straight portion extending in an axial direction. The output of the reduction gear 20 can also be construed as an output of the rotation actuator.

As described above, the strain element 30 includes the force receiver 32, the frame 36, and the plurality of beams 40. In other words, the force receiver 32, the frame 36, and the plurality of beams 40 are constituted by the strain element 30, which is a single member.

### (Strain Gauge-Type Strain Measurement Parts 42)

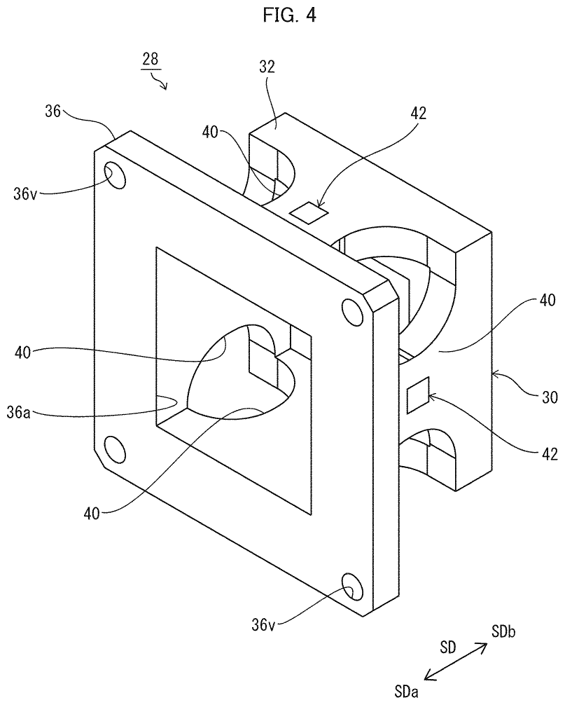

As illustrated in FIG. 1, FIG. 2, FIG. 4, and FIG. 5, the torque sensor 28 includes strain gauge-type strain measurement parts 42 provided on outer side surfaces of the respective beams 40 and configured to measure strains of the beams 40. Each of the strain gauge-type strain measurement parts 42 has a plurality of strain gauges (not illustrated). The measurement of the strains of the beams 40 by the respective strain gauge-type strain measurement parts 42 enables detection of a reaction torque acting on the reduction gear 20. The output torque of the reduction gear 20 (output torque of the rotation actuator) and the reaction torque acting on the reduction gear 20 are in an action-reaction relationship. Therefore, the torque sensor 28 can detect an output torque of the reduction gear 20 (output torque of the rotation actuator) by detecting a reaction torque acting on the reduction gear 20.

Note that the strain gauge-type strain measurement parts 42 may be provided on the inner side surfaces of the respective beams 40 instead of the outer side surfaces of the beams 40. The strain gauge-type strain measurement parts 42 may be provided on the outer side surfaces and the inner side surfaces of the respective beams 40. The strain gauge-type strain measurement part(s) 42 may be provided to at least one beam 40 of the plurality of beams 40 instead of being provided to the respective beams 40. The torque sensor 28 may include capacitive strain measurement parts (not illustrated) or optical strain measurement parts (not illustrated) configured to measure strains of the respective beams 40 instead of the strain gauge-type strain measurement parts 42. The method for providing a strain gauge may be a method for direct film deposition.

According to the configuration of the torque sensor 28 in accordance with Embodiment 1 of the present invention, as described above, the force receiver 32 and the frame 36 are each provided outside the reduction gear case 22 so as to surround the reduction gear case 22. The plurality of beams 40 are disposed around the reduction gear case 22 so as to be spaced from each other. Therefore, the torque sensor 28 does not hinder the connection between the output shaft 24 of the reduction gear 20 and the operation member 12. This makes it possible to connect the output shaft 24 of the reduction gear 20 to the operation member 12 without the need for setting the length of the output shaft 24 of the reduction gear 20 to be larger than the length in an axial direction of the torque sensor 28.

Therefore, according to Embodiment 1 of the present invention, it is possible to reduce a length in an axial direction of the driving mechanism 10 including the rotation motor 14, the reduction gear 20, and the torque sensor 28 to downsize the driving mechanism 10. In particular, since the frame 36 is located closer to the rotation motor 14 than a part of the output shaft 24 of the reduction gear 20 which part protrudes from the reduction gear case 22, it is possible to further reduce a length in an axial direction of the driving mechanism 10 to further downsize the driving mechanism 10 and reduce a risk of wire spooling.

According to the configuration of the torque sensor 28 in accordance with Embodiment 1 of the present invention, as described above, the frame 36 is spaced from the force receiver 32 in an axial direction. Therefore, according to Embodiment 1 of the present invention, it is possible to prevent a size of the torque sensor 28 from increasing in a radial direction of the output shaft 24 of the reduction gear 20 to downsize the torque sensor 28.

Further, according to the configuration of the torque sensor 28 in accordance with Embodiment 1 of the present invention, as described above, the force receiver 32, the frame 36, and the plurality of beams 40 are constituted by the strain element 30, which is a single member. Therefore, according to Embodiment 1 of the present invention, it is possible to reduce the number of parts of the torque sensor 28 to simplify the configuration of the torque sensor 28.

Further, according to the configuration of the torque sensor 28 in accordance with Embodiment 1 of the present invention, the strain gauge-type strain measurement parts 42 are provided to the respective beams 40. Therefore, according to Embodiment 1 of the present invention, the measurement of the strains of the beams by the respective strain gauge-type strain measurement parts 42 enables accurate detection of a reaction torque acting on the reduction gear 20, thereby making it possible to accurately detect an output torque of the reduction gear 20.

### Embodiment 2

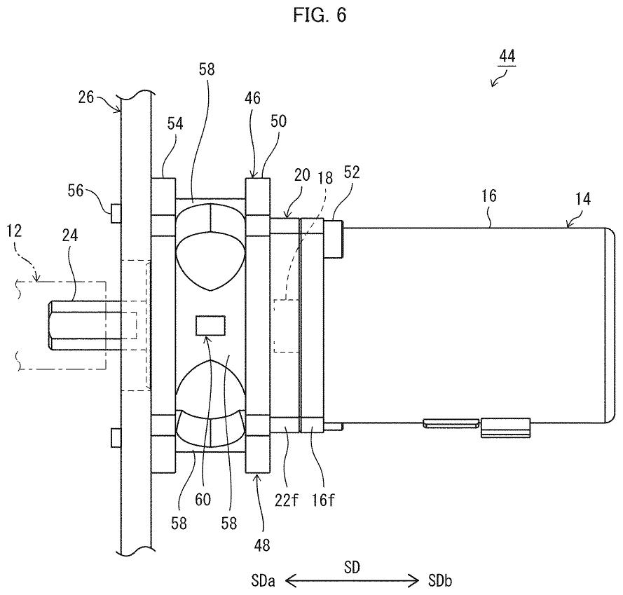

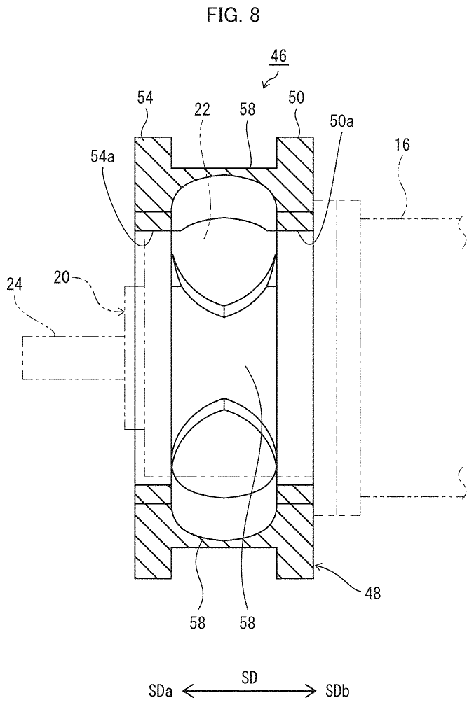

With reference to FIGS. 6 to 10, the following description will discuss Embodiment 2 of the present invention. For convenience of explanation, a member having the same function as a member described in Embodiment 1 is assigned the same reference sign, and the description thereof is not repeated.

### (Overview of Driving Mechanism 44)

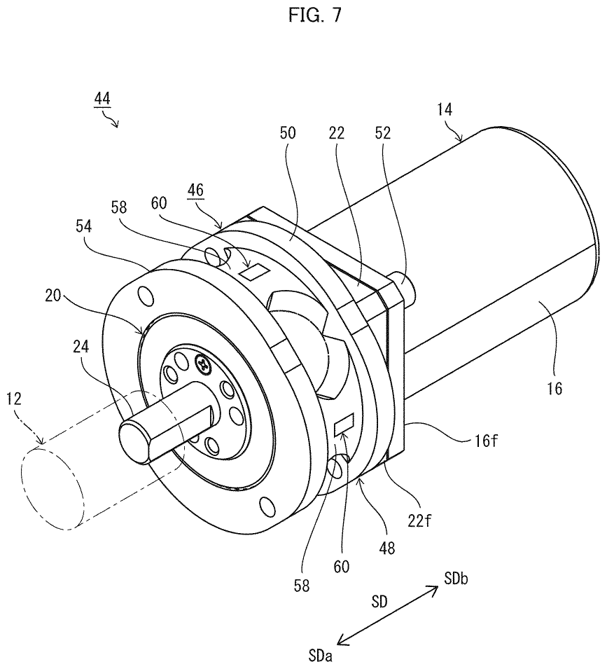

As illustrated in FIG. 6 and FIG. 7, a driving mechanism 44 in accordance with Embodiment 2 of the present invention is a mechanism configured to drive the operation member 12 to rotate and is, for example, used for a joint part of an arm of a robot. The driving mechanism 44 includes the rotation motor 14, the reduction gear 20, and the attachment base 26 as in the case of the driving mechanism 10 (see FIG. 1 and FIG. 2). In the driving mechanism 44, a ring-shaped flange part 22f is formed at an end part on the other side in an axial direction (rear end part) of the reduction gear case 22. The flange part 22f of the reduction gear case 22 is jointed to the flange part 16f of the motor case 16.

### (Overview of Torque Sensor 46)

As illustrated in FIG. 6 and FIG. 7, the driving mechanism 44 includes a torque sensor 46 which is disposed outside the reduction gear case 22 of the reduction gear 20. The detailed configuration of the torque sensor 46 in accordance with Embodiment 2 of the present invention is as follows.

### (Strain Element 48, Force Receiver 50)

As illustrated in FIGS. 6 to 10, the torque sensor 46 includes a strain element 48 disposed outside the reduction gear case 22. The strain element 48 includes a force receiver 50 configured to receive a reaction torque acting on the reduction gear 20. The force receiver 50 is disposed outside the reduction gear case 22 so as to surround the reduction gear case 22. The force receiver 50 is formed into a ring plate shape. In a center part of the force receiver 50, a circular opening 50a through which the reduction gear case 22 is to be inserted is formed. The force receiver 50 is fixed to the flange part 16f of the motor case 16 by a plurality of set screws 52 via the flange part 22f of the reduction gear case 22. The force receiver 50 is provided with a plurality of screw holes 50v to which the set screws 52 are to be fitted. Note that the opening 50a of the force receiver 50 may be formed into a rectangular shape including a square shape.

### (Frame 54)

As illustrated in FIGS. 6 to 10, the strain element 48 includes a frame 54 disposed outside the reduction gear case 22 so as to surround the reduction gear case 22. The frame 54 is spaced from the force receiver 50 in an axial direction and is not in contact with the reduction gear case 22. The frame 54 is formed into a ring plate shape. In a center part of the frame 54, a circular opening 54a through which the reduction gear case 22 is to be inserted is formed. The outer shape of the frame 54 is the same as the outer shape of the force receiver 50. The frame 54 is fixed to the attachment base 26, which is an attachment part, by a plurality of set screws 56. The frame 54 is provided with a plurality of screw holes 54v to which set screws 56 are fitted.

### (Beams 58)

As illustrated in FIGS. 6 to 10, the strain element 48 includes a plurality of beams 58 provided between a side surface on one side in an axial direction (front side surface) of the force receiver 50 and a side surface on the other side in an axial direction (rear side surface) of the frame 54 so as to couple the side surface of the force receiver 50 and the side surface of the frame 54. The plurality of beams 58 are disposed along a circumferential direction around the reduction gear case 22 at equal intervals. The beams 58 are elastically deformable in response to the reaction torque acting on the reduction gear 20, and center parts of the beams 58 each have a constricted shape. The plurality of beams 58 may be disposed at unequal intervals, provided that the plurality of beams 58 are disposed around the reduction gear case 22 so as to be spaced from each other. An edge part of each beam 58 may include a straight portion extending in an axial direction.

As described above, the strain element 48 includes the force receiver 50, the frame 54, and the plurality of beams 58. In other words, the force receiver 50, the frame 54, and the plurality of beams 58 are constituted by the strain element 48, which is a single member.

### (Strain Gauge-Type Strain Measurement Parts 60)

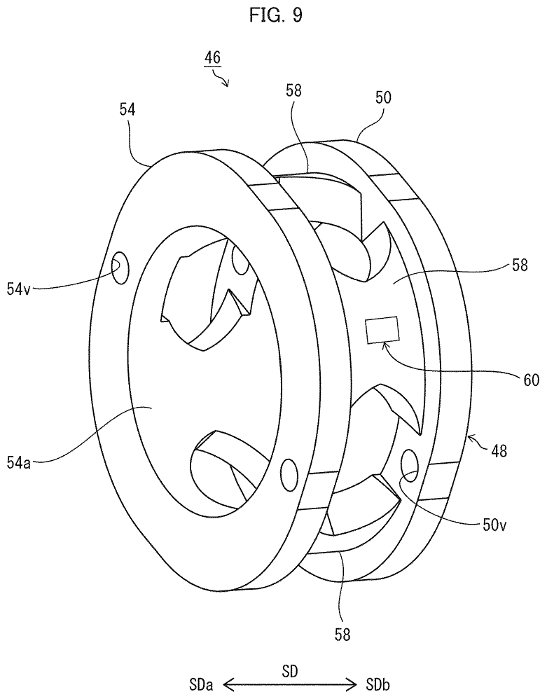

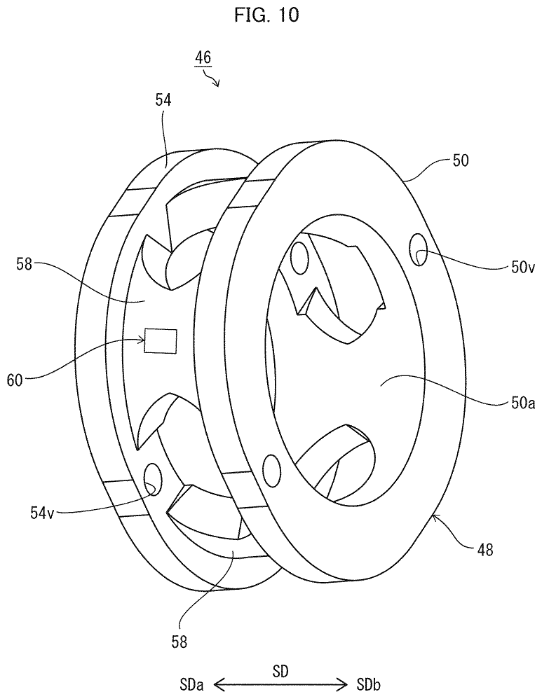

As illustrated in FIG. 6, FIG. 7, FIG. 9, and FIG. 10, the torque sensor 46 includes strain gauge-type strain measurement parts 60 provided on outer side surfaces of the respective beams 58 and configured to measure strains of the beams 58. Each of the strain gauge-type strain measurement parts 60 has a plurality of strain gauges (not illustrated). The measurement of the strains of the beams 58 by the respective strain gauge-type strain measurement parts 60 enables detection of a reaction torque acting on the reduction gear 20. Therefore, the torque sensor 46 can detect an output torque of the reduction gear 20 (output torque of the rotation actuator) by detecting a reaction torque acting on the reduction gear 20 as in the case of the torque sensor 28 described in Embodiment 1.

Note that the strain gauge-type strain measurement parts 60 may be provided on the inner side surfaces of the respective beams 58 instead of the outer side surfaces of the beams 58. The strain gauge-type strain measurement parts 60 may be provided on the outer side surfaces and the inner side surfaces of the respective beams 58. The strain gauge-type strain measurement part(s) 60 may be provided to at least one beam 58 of the plurality of beams 58 instead of being provided to the respective beams 58. The torque sensor 46 may include capacitive strain measurement parts (not illustrated) or optical strain measurement parts (not illustrated) configured to measure strains of the respective beams 58 instead of the strain gauge-type strain measurement parts 60. The method for providing a strain gauge may be a method for direct film deposition.

According to the configuration of the torque sensor 46 in accordance with Embodiment 2 of the present invention, as described above, the force receiver 50 and the frame 54 are each provided outside the reduction gear case 22 so as to surround the reduction gear case 22. The plurality of beams 58 are disposed around the reduction gear case 22 so as to be spaced from each other. Therefore, the torque sensor 46 does not hinder the connection between the output shaft 24 of the reduction gear 20 and the operation member 12. This makes it possible to connect the output shaft 24 of the reduction gear 20 to the operation member 12 without the need for setting the length of the output shaft 24 of the reduction gear 20 to be larger than the length in an axial direction of the torque sensor 46.

Therefore, according to Embodiment 2 of the present invention, it is possible to reduce a length in an axial direction of the driving mechanism 44 including the rotation motor 14, the reduction gear 20, and the torque sensor 46 to downsize the driving mechanism 44. In particular, since the frame 54 is located closer to the rotation motor 14 than a part of the output shaft 24 of the reduction gear 20 which part protrudes from the reduction gear case 22, it is possible to further reduce a length in an axial direction of the driving mechanism 44 to further downsize the driving mechanism 44 and reduce a risk of wire spooling.

According to the configuration of the torque sensor 46 in accordance with Embodiment 2 of the present invention, as described above, the frame 54 is spaced from the force receiver 50 in an axial direction. Therefore, according to Embodiment 2 of the present invention, it is possible to prevent a size of the torque sensor 46 from increasing in a radial direction of the output shaft 24 of the reduction gear 20 to downsize the torque sensor 46.

Further, according to the configuration of the torque sensor 46 in accordance with Embodiment 2 of the present invention, as described above, the force receiver 50, the frame 54, and the plurality of beams 58 are constituted by the strain element 48, which is a single member. Therefore, according to Embodiment 2 of the present invention, it is possible to reduce the number of parts of the torque sensor 46 to simplify the configuration of the torque sensor 46.

Further, according to the configuration of the torque sensor 46 in accordance with Embodiment 2 of the present invention, the strain gauge-type strain measurement parts 60 are provided to the respective beams 58. Therefore, according to Embodiment 2 of the present invention, the measurement of the strains of the beams 58 by the respective strain gauge-type strain measurement parts 60 enables accurate detection of a reaction torque acting on the reduction gear 20, thereby making it possible to accurately detect an output torque of the reduction gear 20.

Aspects of the present invention can also be expressed as follows:

A torque sensor in accordance with Aspect 1 of the present invention is a torque sensor configured to detect a reaction torque acting on a reduction gear in a rotation actuator including a rotation motor and the reduction gear connected in series to the rotation motor, the torque sensor including: a force receiver that is disposed outside a reduction gear case of the reduction gear so as to surround the reduction gear case, that is fixed between a motor case of the rotation motor and the reduction gear case, and that is configured to receive the reaction torque; a frame that is disposed outside the reduction gear case so as to surround the reduction gear case and that is fixed to an attachment part; a plurality of beams that are provided between the force receiver and the frame so as to couple the force receiver and the frame and that are disposed around the reduction gear case so as to be spaced from each other; and a strain measurement part that is provided to at least one beam of the plurality of beams and that is configured to measure a strain of the at least one beam.

According to the above configuration, as described above, the force receiver and the frame are each disposed outside the reduction gear case so as to surround the reduction gear case. The plurality of beams are disposed around the reduction gear case so as to be spaced from each other. Therefore, in a case where the rotation motor, the reduction gear, and the torque sensor are used in combination, the arrangement of the torque sensor with respect to the reduction gear is not in serial, and thus the torque sensor does not hinder the connection between the output shaft of the reduction gear and the operation member. This makes it possible to connect the output shaft of the reduction gear to the operation member without the need for setting the length of the output shaft of the reduction gear to be larger than the length in an axial direction of the torque sensor. As a result, it is possible to reduce a length in an axial direction of the driving mechanism including the rotation motor, the reduction gear, and the torque sensor to downsize the driving mechanism. Note that the reaction torque acting on the reduction gear can be construed as an output torque of the reduction gear (or a rotation actuator). Therefore, an aspect of the present invention serves as a torque sensor configured to detect a reaction torque acting on the reduction gear to detect an output torque of the reduction gear (or the rotation actuator).

A torque sensor in accordance with Aspect 2 of the present invention may be configured, in Aspect 1 above, such that the force receiver, the frame, and the plurality of beams are constituted by a strain element which is a single member.

According to the above configuration, it is possible to reduce the number of parts of the torque sensor to simplify the configuration of the torque sensor.

A torque sensor in accordance with Aspect 3 of the present invention may be configured, in Aspect 1 or 2, such that the frame is located closer to the rotation motor than a part of an output shaft of the reduction gear which part protrudes from the reduction gear case.

According to the above configuration, it is possible to further reduce a length in an axial direction of the driving mechanism to further downsize the driving mechanism.

A torque sensor in accordance with Aspect 4 of the present invention may be configured, in any one of Aspects 1 to 3, such that the frame is spaced from the force receiver in an axial direction.

The above configuration makes it possible to prevent a size of the torque sensor from increasing in a radial direction of the output shaft of the reduction gear to downsize the torque sensor.

### Additional Remarks

The present invention is not limited to the above embodiments, but can be altered by a person skilled in the art within the scope of the claims. The present invention also encompasses, in its technical scope, any embodiment derived by appropriately combining technical means disclosed in differing embodiments.

1. A torque sensor configured to detect a reaction torque acting on a reduction gear in a rotation actuator including a rotation motor and the reduction gear connected in series to the rotation motor, the torque sensor comprising:
a force receiver that is disposed outside a reduction gear case of the reduction gear so as to surround the reduction gear case, that is fixed between a motor case of the rotation motor and the reduction gear case, and that is configured to receive the reaction torque;
a frame that is disposed outside the reduction gear case so as to surround the reduction gear case and that is fixed to an attachment part;
a plurality of beams that are provided between the force receiver and the frame so as to couple the force receiver and the frame and that are disposed around the reduction gear case so as to be spaced from each other; and
a strain measurement part that is provided to at least one beam of the plurality of beams and that is configured to measure a strain of the at least one beam.

2. The torque sensor according to claim 1, wherein the force receiver, the frame, and the plurality of beams are constituted by a strain element which is a single member.

3. The torque sensor according to claim 1, wherein the frame is located closer to the rotation motor than a part of an output shaft of the reduction gear which part protrudes from the reduction gear case.

4. The torque sensor according to claim 1, wherein the frame is spaced from the force receiver in an axial direction.
